(19) United States
(12) Patent Application Publication
(10) Pub. No.: US 2017/0215141 A1
(43) Pub. Date: Jul. 27, 2017

(54) WIRELESS COMMUNICATIONS ENERGY AWARE POWER SHARING RADIO RESOURCES METHOD AND APPARATUS

(71) Applicant: ZTE USA (TX), Austin, TX (US)

(72) Inventor: Carolyn Taylor, Homewood, IL (US)

(21) Appl. No.: 15/328,323

(22) PCT Filed: Jul. 20, 2015
(86) PCT No.: PCT/US2015/041198

§ 371 Date: Jan. 23, 2017

Related U.S. Application Data
(60) Provisional application No. 62/028,879, filed on Jul. 25, 2014.

(51) Int. Cl. H04W 52/02; H04W 24/10; H04W 24/08

(52) U.S. Cl. CPC H04W 52/028; H04W 24/08; H04W 24/10; H04W 88/06

(57) ABSTRACT

The present invention relates to a method for energy aware radio technologies power sharing. A User Equipment (UE) derive the energy required for their operation from batteries. Energy efficiency of these UEs is very important to their usability. Optimal management of the UE power consumption is critical. The biggest energy consumption in a UE is the radio technologies. Energy aware power sharing includes multiple radio access technology (RAT) coordination that deactivates RAT for power sharing of radio resources. Specifically, the invention relates to energy aware radio technologies, consisting of a method to deactivate UE RAT components for power sharing of radio resources using radio resource management (RRM) measurements.

### FIELD OF INVENTION

The present invention relates to wireless communications energy aware power sharing of radio resources.

### BACKGROUND OF THE INVENTION

A wireless communication system includes a plurality of communication devices. The RF transceiver includes a transmitter and a plurality of receivers, each receiving signal from an associated communication device. An Enhanced Node B (eNB) can communicate with a plurality of communication devices in a Multiple-Input Multiple-Output (MIMO) system. The eNB includes a transmitter and plurality of antenna configured to transmit control information. The Reference Signal Received Power (RSRP) is the linear average over the power contributions (in [W]) of the resource elements that carry cell-specific reference signals within the considered measurement frequency bandwidth. The Reference Signal Received Quality (RSRQ) is defined as the ratio N×RSRP/(E-UTRA carrier RSSI), where N is the number of Resource Blocks (RB's) of the E-UTRA carrier Received Signal Strength Indicator (RSSI) measurement bandwidth.

Devices with wireless communications capabilities, such as mobile telephones, handheld devices, devices embedded in laptop computers, Machine-2-Machine devices (M2M), and similar devices, will be referred to herein as User Equipment (UE).

Wireless communications is continuously evolving. There are many advanced technology equipment being introduced that can provide services that were not possible previously. This advanced technology equipment might include, for example, an Enhanced Node B (eNB) rather than a base station or other systems and devices that are more highly evolved than the equivalent equipment in a traditional wireless telecommunications system. Such advanced or next generation equipment may be referred to herein as High Speed Packet Access (HSPA) equipment, long-term evolution (LTE) equipment and long-term evolution (LTE) Advanced equipment.

In traditional wireless telecommunications systems, transmission equipment in a base station transmits signals throughout a geographic region and is called a “cell”. For LTE and other advanced equipment, the region in which a UE can gain access to a wireless communications network might be referred to as a different name, for instance called a “hot spot”. The terminology for example “cell” will be used herein to refer to any geographic region in which a UE can gain access to a wireless communications network, regardless of the type of UE and regardless of whether the region is a traditional cell, a region served by LTE equipment such as an eNB, or some other region in which wireless communications services are available.

Heterogeneous networks (HetNets) consist of a mix of macrocells, remote radio heads, and low-power nodes such as picocells, femtocells, and relays.

Leveraging network topology, increasing the proximity between the access network and the end-users, has the potential to provide the next significant performance leap in wireless networks, improving spatial spectrum reuse and enhancing indoor coverage.

A HetNet is a network consisting of infrastructure points with various wireless access technologies, each of them having different capabilities, constraints, and operating functionalities.

Different UEs might use different types of radio access technology (RAT) to access a wireless communications network. Some UEs, which can be referred to as multi-mode UEs, are capable of communicating using more than one RAT. For example, multi-mode UEs may include UEs that can obtain service from at least one mode of UMTS (Universal Mobile Telecommunications System), and one or more different systems such as GSM (Global System for Mobile Communications) bands or other radio systems. As defined herein, multi-mode UEs may be of any various type of multi-mode UE as defined or provided in 3GPP (3rd Generation Partnership Project), Technical Specification Group (TSG) Terminals, Multi-Mode UE Issues, Categories, Principles and Procedures (3G TR 21.910), which is included herein by reference for all purposes. Some examples of RATs or of network technologies that might use different types of RATs include UTRAN (UTMS Terrestrial Radio Access Network), GSM, GSM EDGE Radio Access Network (GERAN), Wireless Fidelity (WiFi), General Packet Radio Service (GPRS), High-Speed Downlink Packet Access (HSDPA), High Speed Packet Access (HSPA), and long-term evolution (LTE). Other RATs or other network technologies based on these RATs may be familiar to one of skill in the art.

Reference signal received power (RSRP), is the linear average over the power contributions (in [W]) of the resource elements that carry cell-specific reference signals within the considered measurement frequency bandwidth.

For RSRP determination the cell-specific reference signals R0 shall be used. If the UE can reliably detect that R1 is available it may use R1 in addition to R0 to determine RSRP.

The reference point for the RSRP shall be the antenna connector of the UE.

If receiver diversity is in use by the UE, the reported value shall not be lower than the corresponding RSRP of any of the individual diversity branches.

There have been an increasing demand for information access from the growing information and communications technologies (ICT) power consumption. More that 50 percent of the power consumed by the telecommunication industry is due to network operation (including WLANs, LANs, and mobile and fixed line systems).

The wireless communications systems heavily depend on the energy provided by the UE's batteries. UE designers use many different methods to distribute the heat of critical entities within the UE and let the heat dissipate in a moderate way without risk of the UE or users.

The most energy hungry components of the UE mobile radio segment, being responsible for over 80 percent of its power absorption are the radio technologies.

Flexibility in the use of radio resources can be increased and turned into higher energy efficiency.

### BRIEF SUMMARY OF THE INVENTION

An object of the invention is energy aware radio technologies, consisting of a method to deactivate UE RAT components for power sharing of radio resources using radio resource management (RRM) measurements.

Hence, in a first aspect there is provided a multi-mode UE. The multi-mode UE includes a processor configured to promote measurements of a signal strength in a communication system.

In the second aspect the UEs are powered by one or more lithium-ion batteries.

In the third aspect the energy aware radio technologies are measured.

In the fourth aspect deactivate the UE RAT components, and decrease in the energy consumption of spatial diversity techniques.

In the fifth aspect the radio interface allows flexibility in the manipulation of radio resources to be increased and turned into higher energy efficiency for power sharing.

In the sixth aspect a method for a communication network that includes an eNB and at least one multi-mode UE within the communication range of the Serving cell and at least one Neighbor cell. The method includes a transmitter configured for sending, a measurement.

In the seventh aspect a method for measuring signal strength is provided. The method includes creating a criterion that triggers the multi-mode UE to send a measurement report. This can either be periodical or a single event description.

In the eighth aspect the a method that includes a receiver configured for receiving a report to inform about deactivation of one or more UE RAT components and of one or more measurements of signals received by the multi-mode UE from the Serving cell (PCell) and a Neighbor cell, wherein the report includes parameters for deactivating the appropriate one or more UE RAT components.

In the ninth aspect the a method that includes a receiver configured for receiving a report to inform about decrease in the energy consumption for spatial diversity techniques and of measurements of signals received by the multi-mode UE from the Serving cell (PCell) and a Neighbour cell, wherein the report includes parameters for decreasing the radio resources for the spatial diversity techniques.

### BRIEF DESCRIPTION OF THE DRAWINGS

Having thus described the invention in general terms, reference is now made to the accompanying drawings, which are not necessarily drawn to scale. The accompanying drawings are included to provide a further understanding of the invention, and are incorporated in and constitute a part of this specification. The drawings illustrate disclosed embodiments and/or aspects and, together with the description, serve to explain the principles of the invention, the scope of which is determined by the claims.

FIG. 1 is a block diagram of a wireless communications system according to an embodiment of the disclosure.

FIG. 2 is a diagram of a data transmission according to an embodiment of the disclosure.

FIG. 3 is a diagram of a method for measuring signal strength according to an embodiment of the disclosure.

FIG. 4 is a diagram of a wireless communications system including a user equipment and serving cell operable for some of the various embodiments of the disclosure.

FIG. 5 is a diagram of a wireless communications system that illustrates the RATs for power sharing of radio resources using radio resource management (RRM) measurements.

FIG. 6 is a diagram of a wireless communications system that illustrates the energy per bit for detecting downloading data using different radio technologies.

### DETAILED DESCRIPTION OF THE INVENTION

The present inventions now will be described more fully hereinafter with reference to the accompanying drawings, in which some examples of the embodiments of the inventions are shown. It is to be understood that the figures and descriptions provided herein may have been simplified to illustrate elements that are relevant for a clear understanding of the present invention, while eliminating, for the purpose of clarity, other elements found in typical wireless communications energy aware power sharing radio resources. Those of ordinary skill in the art may recognize that other elements and/or steps may be desirable and/or necessary to implement the devices, systems, and methods described herein. However, because such elements and steps are well known in the art, and because they do not facilitate a better understanding of the present invention, a discussion of such elements and steps may not be provided herein. The present disclosure is deemed to inherently include all such elements, variations, and modifications to the disclosed elements and methods that would be known to those of ordinary skill in the pertinent art. Indeed, these disclosure inventions may be embodied in many different forms and should not be construed as limited to the embodiments set forth therein; rather, these embodiments are provided by way of example so that this disclosure will satisfy applicable legal requirements. Like numbers refer to like elements throughout.

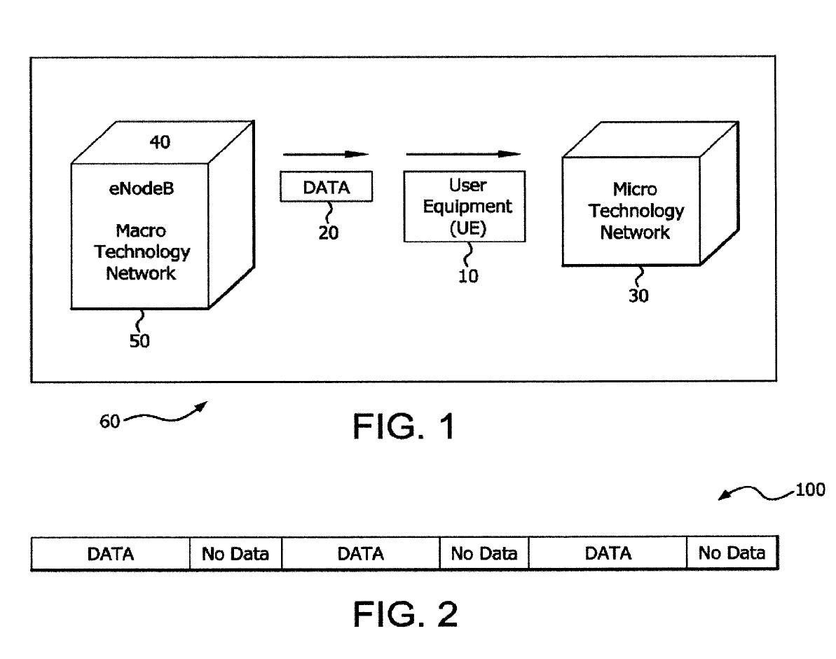

FIG. 1 illustrates a situation in which such a measurement might occur. A UE is moving from a macro technology network toward a micro technology network. The macro technology network includes an eNB, or a similar component. The UE may be engaged in a macro technology running an application via the eNB. That is, the eNB is transmitting data to the UE or is otherwise in communication with the UE.

FIG. 2 illustrates a detailed view of the data transmission from the eNB to the UE. The data transmission consists of a series data strings separated by transmission period in which no data and data is transmitted. The data strings might represent some type of a user-directed data transmission. During the period which no data is transmitted, the UE can measure the strengths of the signals that it receives. In a first technique, a method for measuring signal strength is provided. The method includes the multi-mode UE being measured. In an alternative of this technique, a method for measuring signal strength is provided. The method includes periodic measurements to track and monitor traffic load performance

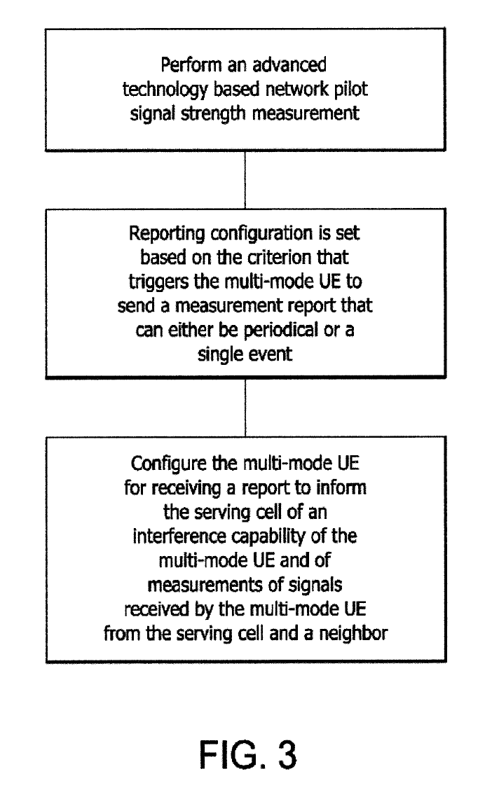

FIG. 3 illustrates an embodiment of a method for measuring the strength of the multi-mode UE of UE according to the loading on the various carriers' capability. The UE send a measurement reporting.

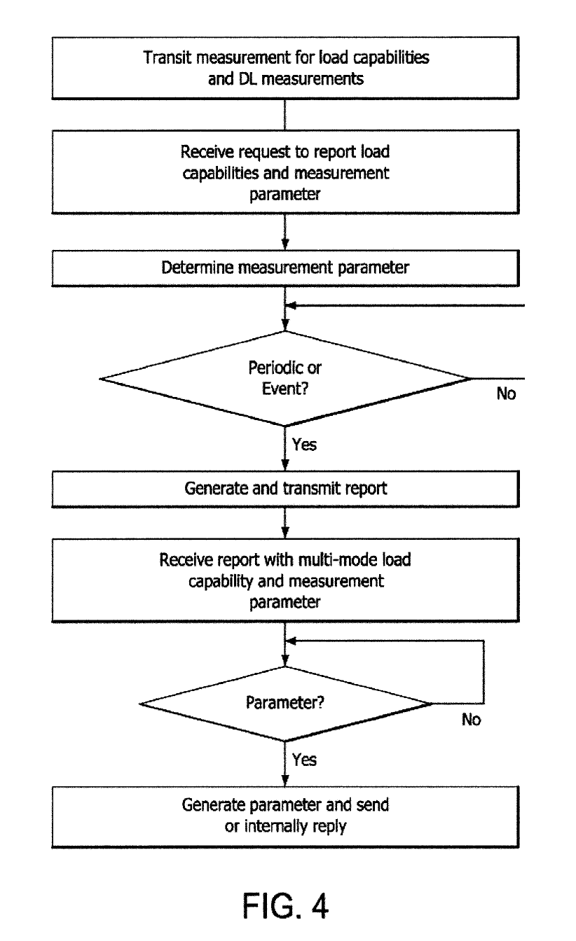

FIG. 4 is a flowchart that illustrates methods of operating a serving cell and a multi-mode UE for a wireless communications system. The serving cell transmits at least one message to at least one multi-mode UE within its cell that the UEs should inform the cell of the capability of the respective UEs and their DL signal measurements, e.g., the RSRP of the serving cell and RSRPs of candidate neighbor cells, which can be macro cells and/or micro/pico/femto cells. The at least one message includes a parameter value for use by a multi-mode UE in determining its parameter according to the loading on the various carriers.

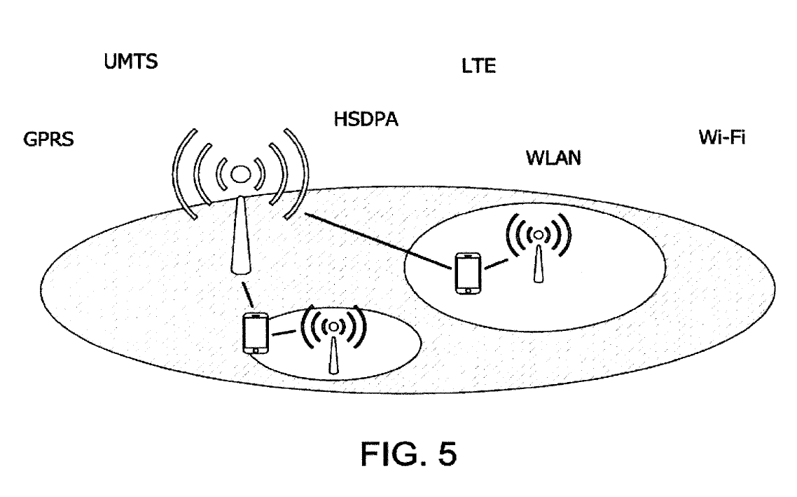

FIG. 5 illustrates an embodiment of a method for energy aware radio technologies, consisting of a method to deactivate UE RAT components for power sharing of radio resources using radio resource management (RRM) measurements.

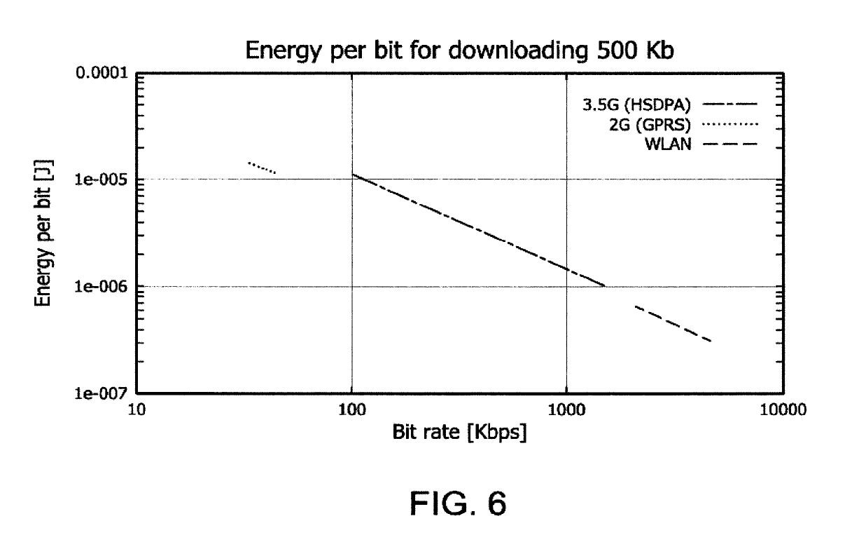

FIG. 6 illustrates an embodiment of a method for energy aware radio technologies power sharing showing the energy per bit for detecting downloading data using different radio technologies.

Although the invention has been described and illustrated in exemplary forms with a certain degree of particularity, it is noted that the description and illustrations have been made by way of example only. Specific terms are used in this application in a generic and descriptive sense only and not for purposes of limitation. Numerous changes in the details of construction and combination and arrangement of parts and steps may be made. Accordingly, such changes are intended to be included in the invention, the scope of which is defined by the claims.

What is claimed as new and desired to be protected by Letters Patent of the United States is:

1. A method to deactivate user equipment (UE) radio access technology (RAT) components for power sharing of radio resources using radio resource management (RRM), the method comprising:
measuring, by a UE having RAT components, a signal strength in a communication system, wherein energy aware radio technologies are measured; and
deactivating one or more UE RAT components and decreasing energy consumption of spatial diversity techniques.

2. The method of claim 1, wherein the UE is powered by one or more lithium-ion batteries.

3. The method of claim 1, where in the UE is a multi-mode UE.

4. The method of claim 1, wherein a radio interface manipulates radio resources to be increased and turned into higher energy efficiency for power sharing.

5. A wireless communication method utilizing an eNB and a UE, wherein the UE is in communication range of a serving cell and a neighbor cell, the method comprising:
sending, by the UE, a measurement report when a criterion is triggered.

6. The method of claim 5, wherein the UE is a multi-mode UE.

7. The method of claim 5, wherein the sending is periodical.

8. A wireless communication system comprising:
a receiver configured to receive a report about: (i) deactivation of one or more UE RAT components and (ii) of one or more measurements of signals received by a UE from a serving cell and a neighbor cell, wherein the report includes parameters for deactivating one or more UE RAT components.

9. The system of claim 8, wherein the UE is a multi-mode UE.
